(19) United States
(12) Patent Application Publication
(10) Pub. No.: US 2025/0325939 A1
(43) Pub. Date: Oct. 23, 2025

(54) DEVICES, SYSTEMS, AND METHODS FOR CAPTURING AND PRODUCING CARBON DIOXIDE

(71) Applicant: Capture6 Corp, Berkeley, CA (US)

(72) Inventors: Ethan Cohen-Cole, Berkeley, CA (US); Luke Shors, Minneapolis, MN (US); Rahul Surana, Fremont, CA (US); Anupam Tiwari, Coralville, IA (US)

(21) Appl. No.: 19/185,072

(22) Filed: Apr. 21, 2025

Related U.S. Application Data
(60) Provisional application No. 63/636,542, filed on Apr. 19, 2024.

(51) Int. Cl. B01D 53/62; B01D 15/36; B01D 53/14; B01D 53/26; B01D 53/78; B01D 53/96; B01D 61/02; B01D 61/46; B01D 61/58; C01B 32/50

(52) U.S. Cl. CPC B01D 53/62; B01D 15/361; B01D 53/1418; B01D 53/265; B01D 53/78; B01D 53/965; B01D 61/58; C01B 32/50; B01D 61/025; B01D 61/027; B01D 61/029; B01D 61/46; B01D 2251/604; B01D 2256/22; B01D 2257/504; B01D 2257/80; B01D 2258/0283; B01D 2258/06; B01D 2311/04

(57) ABSTRACT

Methods, devices, and systems are disclosed that capture carbon dioxide from ambient air and/or point source emissions and produce carbon dioxide from the captured atmospheric and/or point source carbon dioxide using one or more products of the carbon capture processes. Implementations filter atmospheric and/or point source impurities during the carbon capture process and in steps for producing a CO2 stream via chemical synthesis and optionally thermal generation. The integration of CO2 removal processes and chemical synthesis of CO2 synergistically combine to reduce and/or eliminate waste streams, resulting in efficient processes with low carbon emissions and reduced waste.

### CROSS-REFERENCE TO RELATED APPLICATION(S)

This application claims priority to U.S. Provisional Application No. 63/636,542 filed Apr. 19, 2024, and entitled “SYSTEMS AND METHODS FOR CARBON DIOXIDE CAPTURE AND CHEMICAL SYNTHESIS,” which is hereby incorporated by reference in its entirety under 35 U.S.C. § 119 (e).

### TECHNICAL FIELD

The disclosed technology relates to the design of devices, systems, and methods for removing carbon dioxide (CO2) from air and/or point sources, and more particularly relates to chemically synthesizing CO2 after removing CO2 from air and/or point sources.

### BACKGROUND

CO2 is used as an industrial feedstock in a variety of industries. For example, the food and beverage industry uses large quantities of CO2 to carbonate beverages and regulate acidity in foods. Industrial uses of such CO2 require very high-purity products to remain in compliance with regulatory standards. For example, the International Society of Beverage Technologists (ISBT) standard for food-and-beverage-grade CO2 requires a purity level of greater than 99.9% CO2.

Typically, high-purity CO2 is manufactured as a byproduct during hydrogen and ammonia production from natural gas, coal, and hydrocarbon feedstock. Other major sources of CO2 include corn-to-ethanol facilities, CO2-rich natural gas reservoirs, and residual CO2 from biogas production. The CO2 from these processes uses thermal energy and contains a significant level of impurities that must be removed before the CO2 is ready for distribution. Furthermore, the industrial facilities and other CO2 sources used to manufacture high-purity CO2 may be located remotely from the eventual end users of such high-purity CO2, thus necessitating expensive compression and liquefaction for long-distance shipping of CO2.

Direct air capture (DAC) technologies that focus on the removal of atmospheric CO2 provide a carbon-neutral pathway for industrial CO2. The DAC technology also allows modular setup close to the CO2 users, thus reducing the need for compression and shipping expenses. Many of these technologies, however, are not able to produce high-purity CO2 owing to technology constraints. These technologies typically rely on solid membranes, which do not remove impurities present in atmospheric CO2 and which degrade quickly. Liquid absorbents are also used, but these do not remove impurities present in atmospheric CO2 due to thermally intensive desorption processes.

### BRIEF SUMMARY

One general aspect of the disclosed technology involves devices, systems, and methods for synthesizing CO2 while also capturing and removing atmospheric and/or point-source CO2. Various implementations employ a two-stage chemical synthesis process for manufacturing CO2 that includes capturing atmospheric and/or point-source CO2 and re-releasing the CO2 at ambient temperature. In various cases the process reduces and/or avoids the use of high temperatures or thermal energy so that the synthesized CO2 is of high purity and thus requires reduced downstream purification. Avoiding high-temperature regeneration processes restricts the ability of impurity molecules to vaporize into the CO2 gas that is chemically synthesized. An example of the first stage of the disclosed technology includes chemically absorbing atmospheric CO2 and/or a point source of CO2, such as industrial CO2 or impure CO2 from a separate DAC unit, to form mineral carbonates. An example of the second stage of the disclosed technology includes releasing high-purity CO2 from the mineral carbonates using an acid-base neutralization reaction. This two-stage chemical synthesis of CO2 increases CO2 purity as impurities dissolved in the mineral carbonate solution are not released.

Another general aspect of the disclosed technology provides devices, systems, and methods for chemically synthesizing CO2 while capturing and removing CO2 from air and industrial sources, while also simultaneously removing impurities (such as but not limited to nitrates and sulfates), recovering minerals from saline water (e.g., seawater or brackish groundwater), and/or recovering low-TDS (Total Dissolved Solids) water. In particular, implementations of the disclosed technology include electrochemical steps and chemical synthesis steps which can be configured to chemically synthesize CO2. The innovative solutions discussed herein demonstrate the application of the disclosed technology to remove CO2 from air and/or point sources and then synthesize CO2 through the reaction of chemical intermediates produced during electrochemical steps and CO2 removal steps. These synergistic interdependencies between CO2 capture and chemical synthesis of CO2 result in cost-effective solutions for the chemical synthesis of CO2 and removal of unwanted CO2 from, e.g., air and/or industrial sources.

Another general aspect of the disclosed technology provides devices, systems, and methods that integrate chemical synthesis of CO2 with thermal regeneration of CO2. For example, in various cases proportions of chemically synthesized CO2 and thermally regenerated CO2 can be optimized in an integrated configuration based on an amount of industrial emissions and its purity levels.

Various examples and implementations of the disclosed technology include, but are not limited to, the following:

In Example 1, a method for capturing and producing carbon dioxide, comprising electrochemically processing a saline solution to produce a base solution and an acid solution, contacting the base solution with air comprising atmospheric carbon dioxide in an air contactor to produce a carbonate solution comprising carbonates and atmospheric impurities, producing a carbon dioxide stream comprising reacting the carbonate solution with the acid solution without vaporizing the atmospheric impurities, producing a brine byproduct while producing the carbon dioxide stream, and mixing at least part of the brine byproduct with the saline solution.

In Example 2, the method of claim 1, further comprising reacting the carbonate solution with the acid solution at about ambient temperature and about ambient pressure.

In Example 3, the method of claim 1, further comprising contacting the carbonate solution with point source emissions comprising point source carbon dioxide to produce bicarbonates and point source impurities in the carbonate solution and reacting the carbonate solution with the acid solution without vaporizing the point source impurities.

In Example 4, the method of claim 3, wherein reacting the carbonate solution with the acid solution produces a second part of the carbon dioxide stream and further comprising thermally regenerating a first part of the carbon dioxide stream from the carbonate solution before reacting the carbonate solution with the acid solution.

In Example 5, the method of claim 4, wherein reacting the carbonate solution with the acid solution comprises reacting a first portion of the carbonate solution, and further comprising recycling a second portion of the carbonate solution, after thermally regenerating the portion of the carbon dioxide stream, to contact the point source emissions to produce the bicarbonates and the point source impurities.

In Example 6, the method of claim 5, further comprising adjusting the size of the first portion and the size of the second portion based on the amount of the point source impurities.

In Example 7, the method of claim 1, further comprising treating the saline solution with nanofiltration and ion exchange before electrochemically processing the saline solution.

In Example 8, the method of claim 1, further comprising pretreating the saline solution with carbonates from the carbonate solution.

In Example 9, the method of claim 1, further comprising purifying the carbon dioxide stream with a condenser, an absorber, and a liquefier.

In Example 10, a method for capturing and producing carbon dioxide, comprising electrochemically processing a saline solution to produce a base solution and an acid solution, producing a carbonate solution comprising carbonates and atmospheric impurities through direct air capture of atmospheric carbon dioxide, reacting the carbonate solution with point source emissions comprising point source carbon dioxide to produce bicarbonates and point source impurities in the carbonate solution, producing a carbon dioxide stream comprising reacting the carbonate solution with the acid solution while retaining essentially all the atmospheric impurities and point source impurities in a brine byproduct, and mixing at least part of the brine byproduct with the saline solution.

In Example 11, the method of claim 10, further comprising reacting the carbonate solution with the acid solution at about ambient temperature and about ambient pressure.

In Example 12, the method of claim 10, wherein producing the carbon dioxide stream comprises a first stage and a second stage, the first stage comprising thermally regenerating carbon dioxide from the carbonate solution, and the second stage comprising reacting the carbonate solution with the acid solution after the first stage.

In Example 13, the method of claim 12, further comprising adjusting the amount of carbon dioxide made at the first stage and the second stage based on the volume of the point source emissions and the amount of the point source impurities.

In Example 14, the method of claim 12, wherein reacting the carbonate solution with the acid solution comprises reacting a first portion of the carbonate solution, and further comprising recycling a second portion of the carbonate solution for reacting with the point source emissions.

In Example 15, the method of claim 12, wherein the point source emissions are received from an industrial facility and further comprising using waste heat from the industrial facility for thermally regenerating the carbon dioxide in the first stage.

In Example 16, the method of claim 10, further comprising treating the saline solution with nanofiltration, ion exchange, and reverse osmosis before electrochemically processing the saline solution.

In Example 17, the method of claim 10, further comprising purifying the carbon dioxide stream with a condenser, an absorber, and a liquefier.

In Example 18, a system for carbon dioxide capture and production, comprising electrodialysis equipment configured to electrochemically produce a base solution and an acid solution from a saline solution, a direct air capture unit configured to contact the base solution with air comprising atmospheric carbon dioxide to produce a carbonate solution comprising carbonates and atmospheric impurities, a reactor configured to mix the acid solution and the carbonate solution to produce carbon dioxide gas and a brine byproduct comprising essentially all the atmospheric impurities, and a mixer configured to mix the brine byproduct with the saline solution prior to the electrodialysis equipment.

In Example 19, the system of claim 18, further comprising a bubble column reactor configured to contact the carbonate solution with point source emissions to produce bicarbonates and point source impurities in the carbonate solution, wherein the reactor is configured to produce the brine byproduct such that is further comprises essentially all the point source impurities.

In Example 20, the system of claim 19, further comprising a thermal reactor configured to use waste heat from an industrial facility supplying the point source emissions to thermally regenerate at least part of the carbon dioxide gas.

Various additional examples and implementations of the disclosed technology include, but are not limited to, the following:

In Example 21, a method for the simultaneous removal and chemical synthesis of CO2 along with the desalination of saline water, such as seawater or brackish groundwater, comprising inputting liquid; pretreating the liquid for solid precipitation of valuable metals and minerals and impurities using an absorber and hydroxide-rich alkaline solvent and hydrogen-rich compounds; filtration for removal of impurities, such as nitrates and sulfates, in nanofiltration and ion exchange; reverse osmosis processing for recovery of low-TDS water; bipolar electrodialysis (BPED) processing for production of hydroxide-rich alkaline solvent and hydrogen-rich compounds; CO2 capture from air using the hydroxide-rich alkaline solvent in an air contactor with further CO2 capture from point sources, such as industrial sources (e.g., from fossil fuel energy generation) or independent DAC sources; forming mineral carbonates in a bubble column reactor; chemical synthesis of CO2 at atmospheric pressure using hydrogen-rich compounds and mineral carbonates in reactor; separation of synthesized CO2 with a vacuum pump; and CO2 purification with a condenser, an absorber, and a liquefier.

In Example 22, the method of Example 21, wherein condensed impurities, such as nitrates and sulfates, present in saline water such as seawater or brackish groundwater or in atmospheric air and industrial CO2 sources, are removed in a water treatment step that uses nanofiltration and ion exchange using anion exchange resin and then disposed of.

In Example 23, the method of Example 21, wherein gaseous impurities, such as sulfur and nitrates, are removed in the air contactor by dissolving in produced mineral carbonates.

In Example 24, the method of Example 21, wherein gaseous impurities, such as radon, are removed in the air contactor and the bubble column reactor by dissolving in produced mineral carbonates and bicarbonates.

In Example 25, the method in Example 21, wherein the carbonate solution from direct air capture of CO2 is used to absorb point source (e.g., industrially sourced) CO2 and subsequently desorb the absorbed CO2 using low-level waste heat (e.g., preferably from the industrial facility), in addition to the chemical synthesis of CO2.

In Example 26, a method for the simultaneous chemical synthesis of CO2 at atmospheric pressure within a direct air capture and/or point source capture CO2 removal process.

In Example 27, the method according to Example 6, wherein condensed impurities, such as nitrates and sulfates, present in saline water such as seawater or brackish groundwater or in atmospheric air or industrial gases, are removed in nanofiltration and ion exchange using anion exchange resin and disposed or recycled and captured.

In Example 28, the method according to Example 6, wherein gaseous impurities present in CO2 from air are removed in an air contactor by dissolving the gaseous impurities in produced mineral carbonates.

In Example 29, the method according to Example 8, wherein gaseous impurities present in CO2 from point (e.g., industrial) sources, are removed in a bubble column reactor by one or more of:
a) dissolving the gaseous impurities in produced mineral carbonates and bicarbonates and not releasing the gaseous impurities when the CO2 is synthesized; and
b) separating dissolved CO2 gas from insoluble impurities such as oxygen and nitrogen gas.

In Example 30, the method according to Example 9, wherein the absorption of CO2 from atmosphere can be continuous while that from point sources can be intermittent as the resulting mixture of carbonate and bicarbonate is chemically synthesized for release of the absorbed CO2 in a single combined step of acid base neutralization.

In Example 31, the method according to Example 9, wherein the thermal regeneration is coupled with chemical synthesis of CO2 and the ratio of CO2 rereleased based on the two methods can be altered based on the amount of the point source gas and the level of impurities in it.

While multiple embodiments are disclosed, still other embodiments of the disclosure will become apparent to those skilled in the art from the following detailed description, which shows and describes illustrative embodiments of the disclosed devices, systems, and methods. As will be realized, the disclosed devices, systems, and methods are capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 depicts a summary block diagram of a system including synergies and interdependencies between chemical synthesis of CO2 and a CO2 removal process, according to one implementation.

FIG. 2 depicts a summary process flow diagram of chemical synthesis of CO2 occurring at atmospheric pressure, forming gaseous CO2, which is purified in a condenser, absorber, and liquefier, according to one implementation.

FIG. 3 depicts a summary process flow diagram wherein condensed impurities, such as nitrates and sulfates, are removed with ion exchange using anion exchange resin and disposed of, according to one implementation.

FIG. 4 depicts a summary process flow diagram wherein gaseous impurities, such as radon, oxygen, and nitrogen are removed in an air contactor by dissolving in produced mineral carbonates, according to one implementation.

FIG. 5 depicts a summary process flow diagram wherein gaseous impurities, such as radon, are removed in an air contactor and a bubble column reactor by dissolving in produced mineral carbonates and bicarbonates, according to one implementation.

FIG. 6 depicts a summary process flow diagram wherein impurities dissolved in produced mineral carbonates and bicarbonates remain dissolved during the chemical synthesis of CO2, according to one implementation.

FIG. 7 depicts an integrated process flow diagram of chemical synthesis of CO2 wherein input liquid, including the recycled liquid, is cleaned of impurities and then split electrochemically to make solvent for carbon dioxide capture from ambient air and point source(s) (e.g., industrial gases), according to one implementation.

FIG. 8 is a table illustrating experimental testing and subsequent analytical modeling results, according to one implementation.

### DETAILED DESCRIPTION

The various examples and implementations disclosed or contemplated herein relate to devices, systems, and methods for the chemical synthesis of CO2 within a gaseous CO2 removal process. The gaseous CO2 removal process includes one or more of direct air capture and point source capture of CO2. Point sources of CO2 include industrial plants such as factories, refineries, and the like, as well as separate/independent direct air capture units. As noted above, many current DAC technologies are not able to produce high-purity CO2 owing to technology constraints. Various implementations of the disclosed technology accept CO2 with undesirable levels of impurities from other DAC facilities operating with older technology. These types of DAC facilities are considered potential point sources of CO2 for purposes of the disclosed technology. As used herein, references to point sources as industrial, DAC, or another type imply the potential use of alternative point sources of CO2 unless otherwise specified.

In various cases the combined process is tightly integrated, with several interdependencies and synergies, leading to an efficient system resulting in low carbon emissions and reduced waste. For example, various implementations of the disclosed technology can produce CO2 on site, without the need for expensive compression and liquefaction of CO2 that is needed for long-distance transportation, can reduce or eliminate the need for extensive purification processes needed for some thermally regenerated CO2, and/or can include an optimized configuration for producing both chemically synthesized CO2 and thermally regenerated CO2 in a proportion based on, for example, supply volumes and purity levels. Additional examples and implementations disclosed or contemplated herein relate to devices, systems, and methods that remove impurities. This includes, among others, devices, systems, and methods that can remove and separate impurities for recovery or disposal.

Various implementations incorporate one or more aspects of the DAC and point source capture systems and methods disclosed in co-owned U.S. Pat. Appl. Publ. US 2023/0191322 A1, filed Dec. 16, 2022, and titled “Systems and Methods for Direct Air Carbon Dioxide Capture,” and in U.S. Pat. Appl. Publ. US 2024/0123400 A1, filed Oct. 4, 2023, and titled “Systems and Methods for Integrated Direct Air Carbon Dioxide Capture and Desalination Mineral Recovery,” both of which are hereby incorporated herein by reference in their respective entireties. Accordingly, unless otherwise specified, one or more aspects of various carbon dioxide capture systems disclosed herein can be implemented based on the teachings in US 2023/0191322 A1 and US 2024/0123400 A1. These incorporated patent publications are sometimes referred to herein as the “incorporated publications” for convenience.

As already noted, various devices, systems, and methods are disclosed herein for simultaneous chemical synthesis of CO2 as part of a CO2 removal process. Implementations of the disclosed devices, systems, and methods may employ one or more of the following elements: saline water, such as seawater or brackish groundwater; pretreatment with nanofiltration, ion exchange, and/or chemical precipitation; nitrate removal with ion exchange or electrochemical processes, such as bipolar electrodialysis (BPED); hydroxide-rich alkaline solvent and hydrogen-rich compound production with BPED; CO2 removal from air and/or point sources, such as industrial sources and independent DAC units, with an air contactor and a bubble column reactor, respectively; low-TDS water recovery with reverse osmosis; valuable trace mineral extraction with an absorber, a hydroxide-rich alkaline solvent, and hydrogen-rich compounds; chemical synthesis of CO2 with a continuous stirred-tank reactor, a vacuum pump, a hydroxide-rich alkaline solvent, and hydrogen-rich compounds; and CO2 purification and processing with a condenser, a scrubber, and a liquefier.

The standard process for synthesizing CO2, steam reformation of methane, reacts methane gas with steam at high temperatures and pressures. This process yields large quantities of both hydrogen and CO2, both of which are used as industrial feedstocks. The high temperatures and pressures required for this process necessitate a large energy input, typically in the form of fossil fuel consumption. This, in turn, contributes to global carbon emissions. Whereas commercially available DAC and point-source capture (PSC) processes exist for synthesizing CO2 from atmospheric and other sources (e.g., industrial) of CO2, respectively, these processes typically rely on solid membranes, which do not remove impurities and degrade quickly, or liquid absorbents, which do not remove impurities present in atmospheric CO2 and which require thermally intensive desorption processes.

In various implementations, carbon capture technology and equipment can be modified, reconfigured, or otherwise incorporated within systems and methods for chemically synthesizing CO2. For example, various electrodialysis processes and air contactor and bubble column reactor processes disclosed in the incorporated publications are configured to produce hydrogen-rich and mineral-carbonate compounds, respectively, which can be reacted in a reactor to chemically synthesize CO2. In various implementations, the reactor may be an agitated reactor such that reactions within the reactor behave according to a continuously stirred tank reactor (CSTR) model. In other implementations, other reactors styles may be used, such as unagitated reactors that would contain reactions behaving similar to a plug flow reactor model. Chemically synthesized CO2 is then separated with a vacuum pump and purified with a condenser, a scrubber, and a liquefier.

In various implementations certain portions of the carbon capture and CO2 rerelease processes can be segregated depending on the location needs. For example, the carbonates from direct air capture of carbon dioxide can be transported to an industrial or other type of CO2 source facility to enable the capture and re-release of the industrial or other type of CO2. In such a case, the sodium carbonate from the DAC facility can be transported to the point source facility to absorb the point source (e.g., industrial) CO2, thus forming sodium bicarbonate. The sodium bicarbonate can then desorb the CO2 easily at a slightly higher temperature, using the waste heat from the industrial facility, thereby recovering sodium carbonate solution for further industrial CO2 capture.

Additionally, in various implementations air contactor and bubble column reactor processes effectively remove gaseous impurities from CO2 that have been captured from air and industrial sources, respectively, even from low CO2 concentrations. The gaseous impurities are removed by dissolving them into the mineral carbonates produced by these processes and preventing them from degassing during the chemical synthesis of CO2. Gaseous impurities, such as sulfur and radon, are commonly found in geothermal CO2 emitted from geothermal power plants. Impurities in other industrial CO2 gases include atmospherics such as oxygen, nitrogen, and hydrocarbons such as methanol. Impurities such as nitrates and sulfates are commonly found in atmospheric CO2. These impurities are removed in various implementations during CO₂ absorption, water treatment, and air contactor steps so that high-purity CO2 is desorbed. The high-purity CO2 evolution in such implementations eliminates incremental purification costs typically incurred with low-purity CO2. In various implementations, depending on the amount of industrial CO2 and its purity levels, the proportions of chemically synthesized CO2 and thermally regenerated CO2 can be optimized in an integrated configuration.

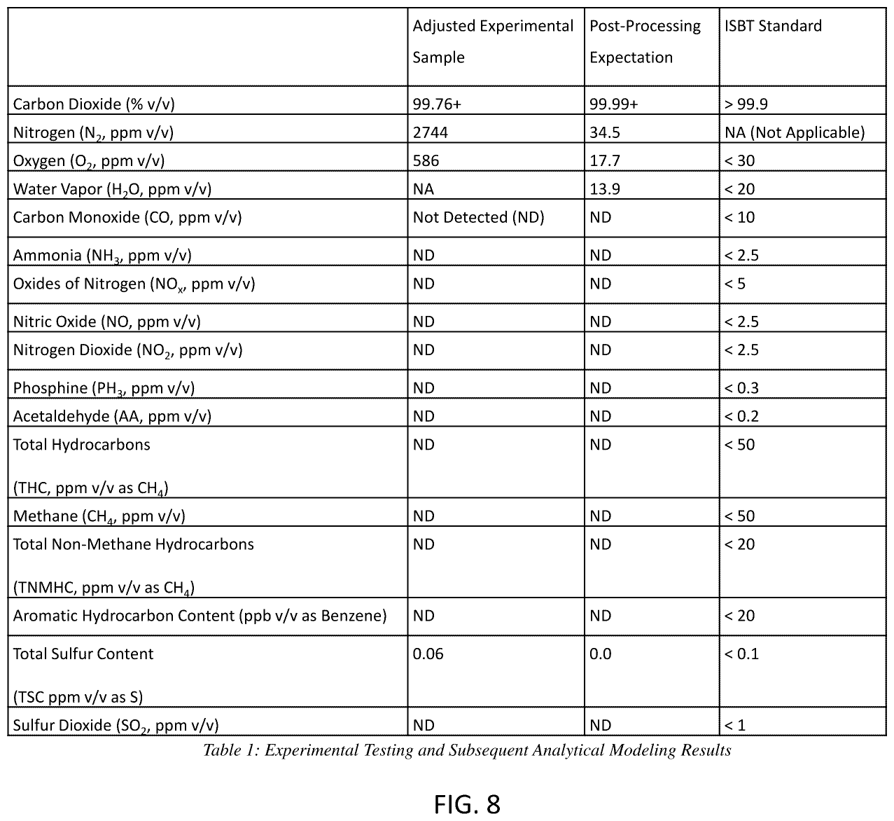

Experimental testing and subsequent analytical modeling of aspects of the disclosed technology indicates that implementations of the technology are capable of chemically synthesizing CO2 and purifying the CO2 to the level required by the regulatory standards for food-and-beverage-grade CO2 set by the International Society of Beverage Technologists (ISBT). The results of this experimental testing and subsequent analytical modeling are presented in Table 1 in FIG. 8. Note that not all values in Table 1 have the same units.

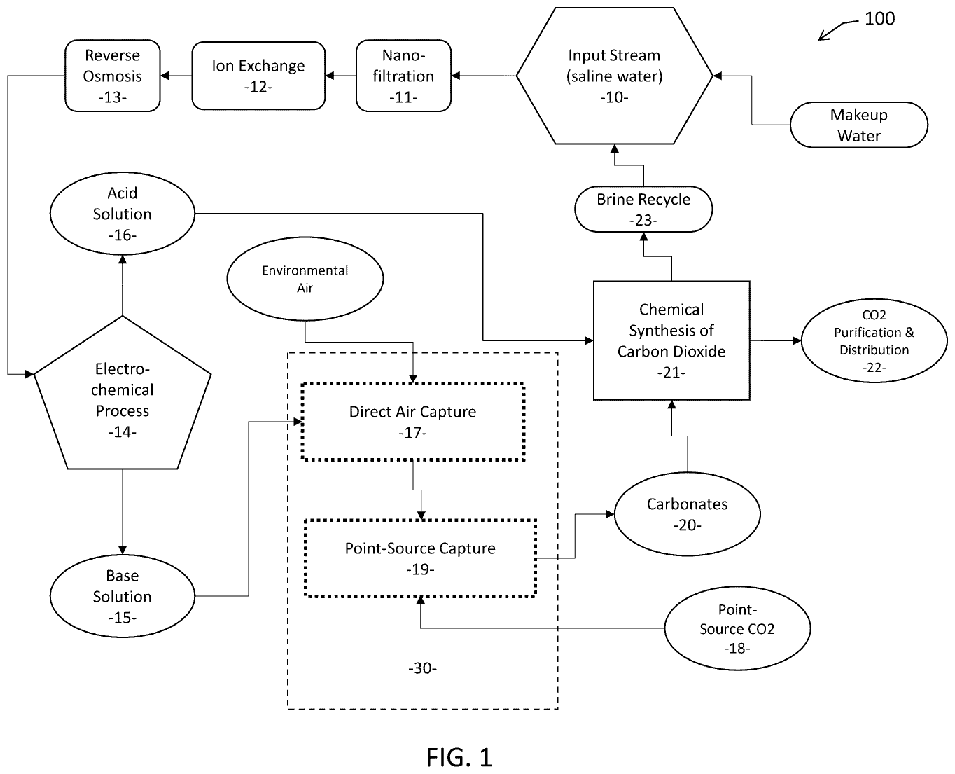

Turning now to the drawings, FIG. 1 depicts a system 100 using simultaneous chemical synthesis of CO2 within a CO2 removal process according to various implementations. An input saline water 10 is fed into the CO2 removal system 100, filtered 11 to remove coarse particles and divalent ions, such as calcium and magnesium, and passed through a final polishing step 12 for divalent ion reduction. This polishing step 12, which involves ion exchange, can be reconfigured to remove impurities condensed in the input stream 10, thus integrating the impurity reduction within the CO2 removal process. As an example, in various implementations the ion exchange device 12 uses an ion exchange resin to adsorb impurities. In some cases the ion exchange resin can be a “nitrate specific resin” (NSR) that specifically targets and removes nitrate impurities. Other resins can be used to target one or more additional or alternative impurities.

Following the ion exchange member/polishing step 12, the input saline water 10 may be passed through a reverse osmosis unit 13 to concentrate it. The concentrated input saline water may then be sent to an electrochemical process, such as BPED, 14 to produce a hydroxide-rich alkaline solvent 15, such as sodium hydroxide, and hydrogen-rich compounds 16, such as hydrochloric acid. As would be understood, the electrochemical process may occur in various equipment configured to electrochemically split water molecules into hydroxide ions and hydrogen ions, such as but not limited to electrodialysis stacks, electrodialysis membranes, and the like (collectively, “electrodialysis equipment” 84, discussed below). As would also be understood, a solution containing a majority of the hydroxide ions resulting from the electrochemical process would form the hydroxide-rich alkaline solvent 15, also known as and referred to herein as a base solution 15, which may have a pH above 7. Additionally, a solution containing a majority of the hydrogen ions resulting from the electrochemical process would form the hydrogen-rich compounds 16, also known as and referred to herein as an acid solution 16, which may have a pH below 7.

The base solution 15 may then be contacted with carbon dioxide containing material 8 like atmospheric air, such as through DAC or PSC, as discussed below. The equipment used to contact the carbon dioxide containing material 8 with the base solution 15 may be generally referred to as carbon-absorption equipment, liquid-gas contactors, and the like, with more specific equipment discussed below.

Some, or all, of the base solution 15 may then be passed through an air contactor 17 which removes CO2 from the air and produces mineral carbonates in the base solution 15 (DAC).

The base solution 15 may also be passed through a point source capture device, such as a bubble column reactor 19, that removes CO2 from point source (e.g., industrial) gases 18, thereby producing mineral bicarbonates 20. The base solution 15 may be contacted in various other methods with carbon dioxide rich materials 8 to produce the mineral carbonates 20. In various implementations, the carbonates 20 may be a solution containing carbonate ions (CO32-), bicarbonate ions (HCO3-), or the like. The carbonates 20 may likewise be in solution with various cations, such as but not limited to sodium, calcium, potassium, and the like.

Impurities in CO2 that are not soluble in the mineral carbonate solution, such as oxygen, nitrogen, and hydrogen, are easily removed during the absorption step. Furthermore, the impurities that are soluble in mineral carbonates, such as methanol, and gaseous impurities such as radon, are effectively “removed” from the synthesized CO2 by preventing them from degassing during the chemical synthesis 21. Once the base solution 15 is saturated with carbon, in the form of produced mineral carbonates and bicarbonates 20, it is reacted with hydrogen-rich compounds 16 in a reactor (not shown in FIG. 1) to chemically synthesize CO2 22. The CO2 is then purified and distributed 22. The brine byproduct 23 of this step is recycled to the input saline water 10. In various implementations the recycled brine byproduct may contribute up to about 90% of the input saline water, in which case the remaining 10% may be make up water.

In various implementations, the chemical synthesis 21 of CO2 is done at about ambient temperature and at about ambient pressure. Conducting the chemical synthesis 21 of CO2 through the reaction of the carbonates 20 and acid solution 16 at about ambient temperature may yield higher purity CO2 than would be achievable through other CO2 production methods, such as thermal regeneration. The impurities may dissolve into the carbonate 20 stream or the carbonates 20 themselves during various steps of the system 100, or the impurities may be found in the input stream 10. Some of the impurities, such as but not limited to sulfur compounds, nitrogen compounds like nitrates, and radon, may be readily vaporized and may mix with any produced CO2, especially when the temperature of the impurities is increased. By conducting the chemical synthesis 21 of CO2 at about ambient temperature, the impurities may remain dissolved in the carbonate 20 stream or the carbonates 20 themselves, resulting in an increase in purity of the gaseous CO2. In various implementations, essentially all of the impurities may fail to vaporize, meaning the gaseous CO₂ is essentially pure. For the purposes of this disclosure, “essentially all” impurities failing to vaporize, or remain in the brine byproduct, means that the amount of impurities remaining in the carbonate 20 solution is sufficient to ensure the purity of the resulting gaseous CO₂ is at least about 99.7%, at least about 99.76%, or higher.

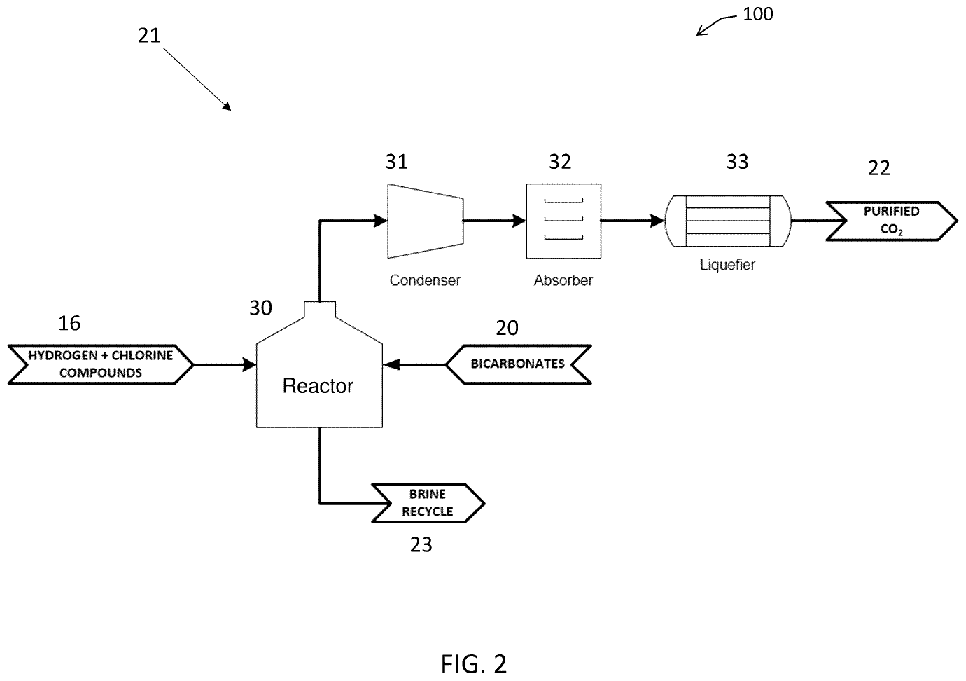

FIG. 2 depicts an example of the chemical synthesis 21 of CO2 that forms part of the system 100 according to various implementations. Mineral bicarbonates and hydrogen-rich compounds, such as are produced and processed as depicted in FIG. 1, are reacted in a reactor 30, forming CO2 and byproduct brine which is recycled to the input saline water as depicted in FIG. 1. In certain implementations, the reactor 30 may be a single reactor vessel. In other implementations, the reactor 30 may be two or more reactor stages linked together, such as a first reactor stage and a second reactor stage, which will be discussed in detail below. In further implementations, the reactor 30 may have any number of reactor stages that may be effective and efficient in producing CO2.

The CO2 is then purified by first passing through a condenser 31 which condenses any condensable impurities, such as water. These condensed impurities are separated as the CO2 then passes through an absorber 32. Finally, the CO2 passes through a liquefier 33 which liquefies the CO2 and separates out any non-condensable impurities, such as nitrogen and oxygen gases. The purified liquid CO2 can then be readily distributed.

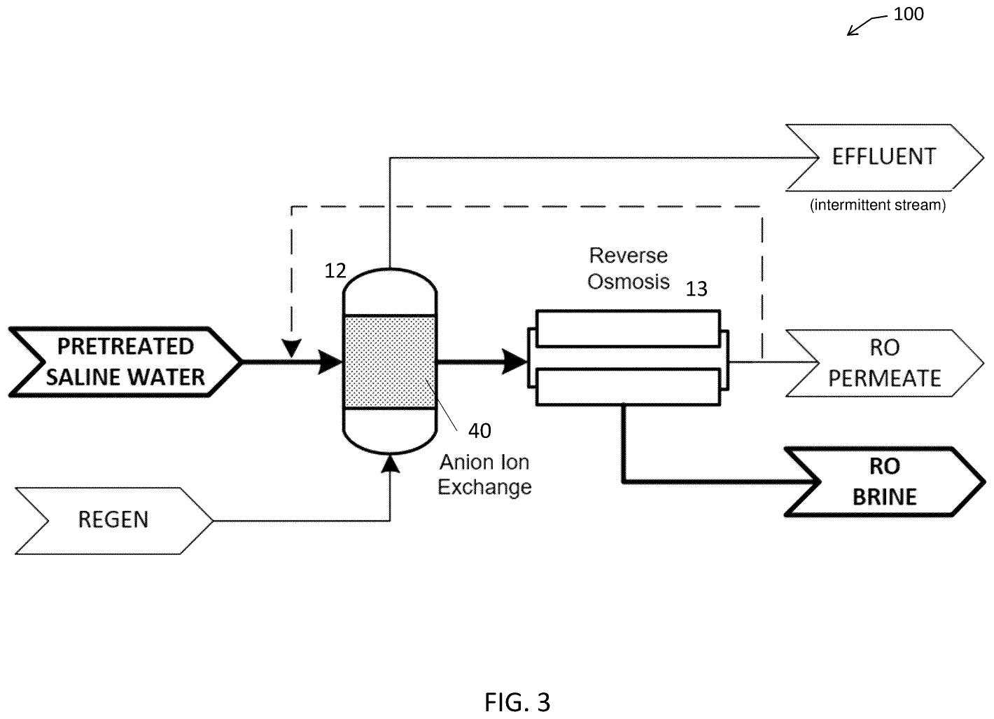

FIG. 3 depicts, according to various implementations, an example of the ion exchange 12 and reverse osmosis 13 treatment stages for the input saline water 10 as depicted in the system 100 of FIG. 1. As shown in FIG. 3, the pretreated saline water (e.g., treated by the filter stage 11) is passed through an ion exchange 12 using an anion exchange resin 40. The resin is typically selective for condensed impurities, such as nitrates, which it readily adsorbs. Once the resin is saturated (or loaded) with impurities, it is regenerated using an anion-rich stream which desorbs the impurities and discharges them in an effluent stream. The effluent stream is then either returned to a water source or further processed to separate and recover the impurities.

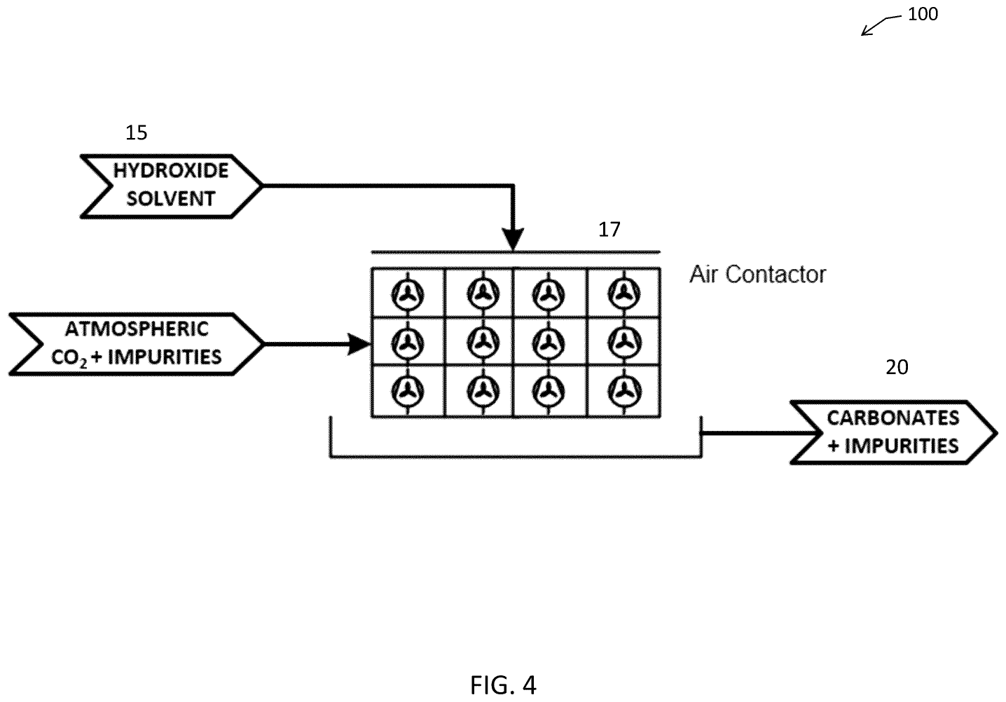

FIG. 4 illustrates details of the direct air capture of CO2 as depicted in FIG. 1. Base solution 15, processed as depicted in FIG. 1, is passed through an air contactor 17 which removes CO2 from the air, producing mineral carbonates. Any gaseous impurities, such as radon, present in the captured CO2 are dissolved into the produced mineral carbonates.

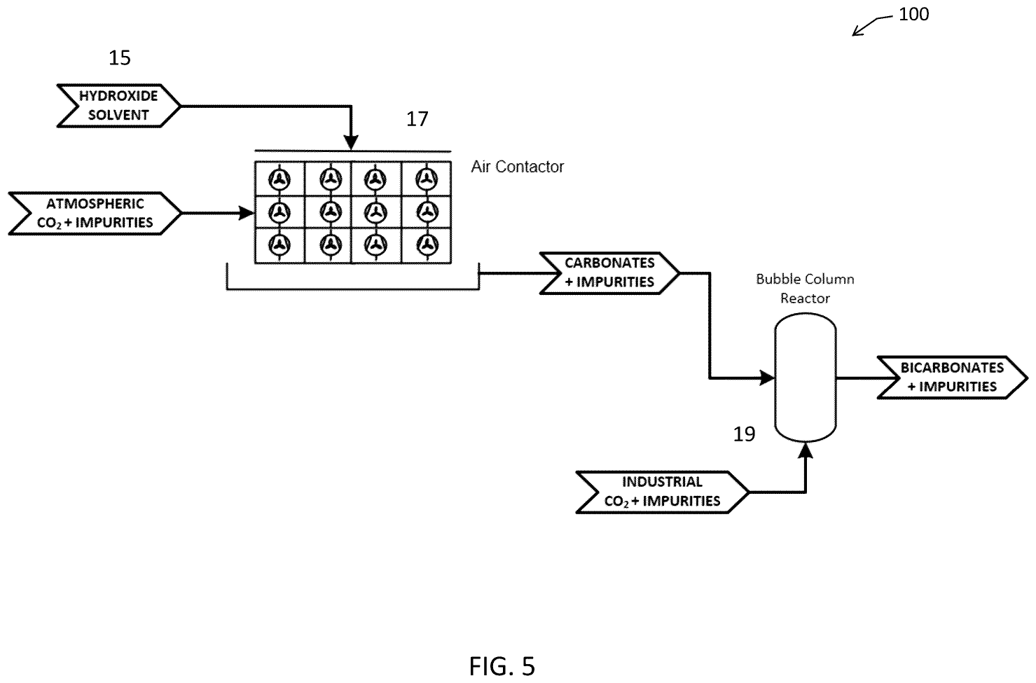

FIG. 5 depicts an example of two CO2 capture stages according to various implementations. Base solution 15, processed as depicted in FIG. 1, is passed through an air contactor 17 which removes CO2 from the air, producing mineral carbonates 20. Any gaseous impurities, such as but not limited to sulfur and nitrates, present in the air are dissolved into the produced mineral carbonates 20. The produced mineral carbonates 20 are then passed through a bubble column reactor 19 which removes CO2 from industrial sources, producing mineral bicarbonates 20. Any gaseous impurities present in the industrial gases are either not absorbed in the carbonate 20 solution or are dissolved into the mineral carbonates 20 and stay in the liquid phase resulting in high-purity chemically synthesized CO2. In various implementations the bubble column reactor 19 may also or instead accept CO2 from other point sources, including independent DAC units.

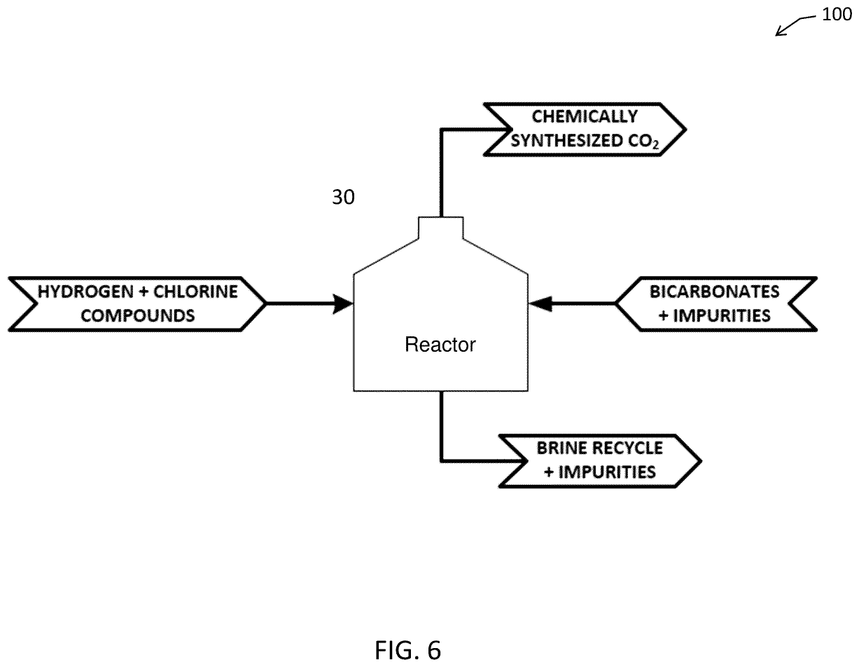

FIG. 6 depicts one implementation of the chemical synthesis of CO2 as depicted in FIG. 1. Produced mineral bicarbonates and hydrogen-rich compounds, processed as depicted in FIG. 1, are reacted in a reactor 30, forming CO2 and byproduct brine 23 which is recycled to the input saline water as depicted in FIG. 1. Impurities dissolved in the produced mineral bicarbonates 20 do not degas during CO₂ synthesis and remain dissolved in the byproduct brine 23. These impurities are removed after recycling during brine pretreatment.

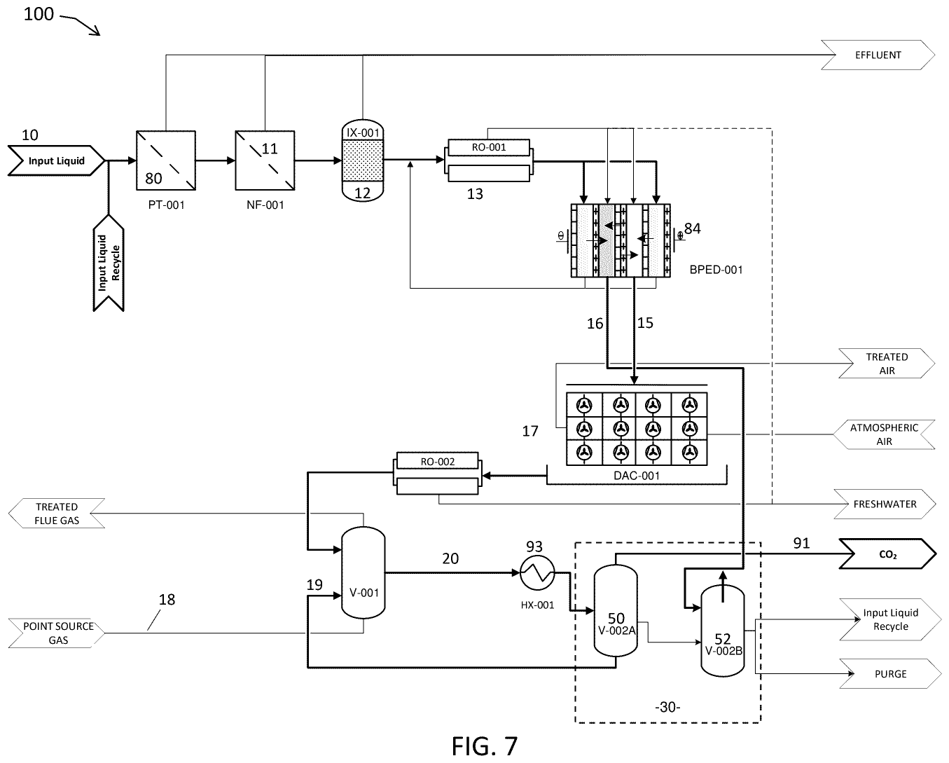

FIG. 7 depicts the system 100 configured for chemical and thermal synthesis of CO2 with a multi-stage reactor 30 according to various implementations. As discussed above, the reactor 30 may include two or more linked stages. In various implementations the reactor 30 includes a first reactor stage 50 that may be a thermal reactor 50 configured to heat carbonates 20 sufficiently to cause thermal decomposition of the carbonates 20, which may produce CO2 and metal oxides, with the metal coming from cations present in solution. As would be understood, this process of thermal decomposition of carbonates 20 may be referred to as thermal regeneration.

As would be understood, the use of thermal regeneration in tandem with chemical synthesis may increase the total amount of CO2 produced in implementations where high purity is not necessary. In addition, in various cases the use of thermal regeneration may be used to produce additional amounts of CO2 when the purity of the point source emissions is relatively high, whereas thermal regeneration may be used to produce smaller amounts of CO2 when the purity of the point source emissions is relatively low.

In some implementations, a second reactor stage 52 may be a chemical synthesis reactor 52 that is configured to mix the acid solution 16 with the carbonates 20, whereby the acid solution 16 and carbonates 20 can chemically react to produce CO2, salts, and water. As would be understood, this process of chemical reaction between the acid solution 16 and carbonates 20 may be referred to as chemical synthesis.

Continuing with FIG. 7, the input saline solution 10, including the recycled liquid, may be first cleaned of impurities using various treatment steps, including pretreatment 80, nanofiltration 11, ion exchange 12, and reverse osmosis 13. In various implementations, the pretreatment 80 may include treating the input saline solution 10 with carbonates to remove various minerals. After reverse osmosis 13, the treated saline solution 10 may be electrochemically split in electrodialysis equipment 84 into a base solution 15 and an acid solution 16. The base solution 15 may be passed through an air contactor 17 along with ambient air and the carbon dioxide from the gas phase is absorbed into the liquid phase forming carbonates, which may be dilute in the overall solution. The carbonates are further infused with CO2 from point source emissions 18 (e.g., sometimes referred to herein as point source gas, from, e.g., industrial flue gas) to form bicarbonates in a bubble column reactor 19. The resulting bicarbonates 20 can be used with the multi-stage reactor 30 to re-release the CO2 91 either thermally by heating the carbonates 20 with a waste heat pump 93 to remove CO2 in the thermal reactor stage 50 and/or chemically using the acid solution 16 in the chemical synthesis reactor stage 52.

In various implementations, the heat pump 93 may be operated with waste heat from an industrial process, for example, that generates the point source gas 18. In various implementations the heat pump 93 and reactor 50 process the bicarbonates stream 20 to release CO2, after which the resulting carbonates 20 may be recycled back to the bubble column reactor 19 to capture additional CO2 from the point source gas 18. This process can be repeated multiple times to thermally generate additional CO2 before streaming the carbonates to the second reactor stage 52. In various cases the recycled carbonates 20 are combined with make-up carbonates from the air contactor 17 before repeating the process.

In various implementations the process and the reactors 30 can be configured in a fashion such that the ratio of thermal regeneration of CO2 to chemical synthesis can vary based on the amount of industrial flue gas and the impurities in it. As would be understood, the ratio between thermal regeneration of CO2 and chemical synthesis of CO2 would be measured as a ratio of the masses of CO2 produced through each method for a given period of time. As an example of varying the ratio of thermal regeneration to chemical synthesis, in various cases the point source (e.g., industrial) CO2 has a high impurity level. In such cases the system 100 is configured to use the sodium bicarbonate solution 20 to thermally regenerate CO2 and then recycle a smaller amount of the solution back to the bubble column reactor 19 while purging a larger amount of the carbonates 20 to the reactor 30, optionally more particularly the second reactor stage 92, as the solution containing the carbonates 20 becomes loaded with the impurities and needs water treatment to be cleaned. In this case the ratio of thermal regeneration to chemical synthesis may be relatively low such as, for example, about 1:1 or about 2:1. In an alternative scenario, the CO2 gas from the point source 18 may be purer (e.g., flue gas from an ethanol facility). In such cases the system 100 is configured to use the sodium bicarbonate solution 20 to thermally regenerate CO2 many more times (e.g., about 10-20 times) before the solution containing the carbonates 20 becomes loaded with the impurities and needs water treatment. In such cases the ratio of thermal regeneration to chemical synthesis may be relatively high such as, for example, from about 10:1 to about 20:1. In some cases the first reactor stage 94 may continuously purge a small percentage (e.g., 1-5% or more) of the carbonates stream to the chemical synthesis reactor in order to prevent the level of impurities from increasing above a desired level.

In various cases the amount of available point source CO2 may be relatively low. In such cases the ratio of thermal to chemical synthesis will be low, while the ratio will be higher if the amount of available industrial CO2 is also high.

As described herein, it is understood that the illustrated systems and processes for implementing the CO2 removal and synthesis processes comprise one or more fluidic and/or electrical connections (shown generally by the connecting lines) between a variety of optional components that can be arranged in a wide variety of configurations, such that the various fluids, gases, and electricity are able to flow as described.

Although the disclosure has been described with reference to preferred embodiments, persons skilled in the art will recognize that changes may be made in form and detail without departing from the spirit and scope of the disclosed devices, systems, and methods.

What is claimed is:

1. A method for capturing and producing carbon dioxide, comprising:
electrochemically processing a saline solution to produce a base solution and an acid solution;
contacting the base solution with air comprising atmospheric carbon dioxide in an air contactor to produce a carbonate solution comprising carbonates and atmospheric impurities;
producing a carbon dioxide stream comprising reacting the carbonate solution with the acid solution without vaporizing the atmospheric impurities;
producing a brine byproduct while producing the carbon dioxide stream; and
mixing at least part of the brine byproduct with the saline solution.

2. The method of claim 1, further comprising reacting the carbonate solution with the acid solution at about ambient temperature and about ambient pressure.

3. The method of claim 1, further comprising contacting the carbonate solution with point source emissions comprising point source carbon dioxide to produce bicarbonates and point source impurities in the carbonate solution and reacting the carbonate solution with the acid solution without vaporizing the point source impurities.

4. The method of claim 3, wherein reacting the carbonate solution with the acid solution produces a second part of the carbon dioxide stream and further comprising thermally regenerating a first part of the carbon dioxide stream from the carbonate solution before reacting the carbonate solution with the acid solution.

5. The method of claim 4, wherein reacting the carbonate solution with the acid solution comprises reacting a first portion of the carbonate solution, and further comprising recycling a second portion of the carbonate solution, after thermally regenerating the portion of the carbon dioxide stream, to contact the point source emissions to produce the bicarbonates and the point source impurities.

6. The method of claim 5, further comprising adjusting the size of the first portion and the size of the second portion based on the amount of the point source impurities.

7. The method of claim 1, further comprising treating the saline solution with nanofiltration and ion exchange before electrochemically processing the saline solution.

8. The method of claim 1, further comprising pretreating the saline solution with carbonates from the carbonate solution.

9. The method of claim 1, further comprising purifying the carbon dioxide stream with a condenser, an absorber, and a liquefier.

10. A method for capturing and producing carbon dioxide, comprising:
electrochemically processing a saline solution to produce a base solution and an acid solution;
producing a carbonate solution comprising carbonates and atmospheric impurities through direct air capture of atmospheric carbon dioxide;
reacting the carbonate solution with point source emissions comprising point source carbon dioxide to produce bicarbonates and point source impurities in the carbonate solution;
producing a carbon dioxide stream comprising reacting the carbonate solution with the acid solution while retaining essentially all the atmospheric impurities and point source impurities in a brine byproduct; and
mixing at least part of the brine byproduct with the saline solution.

11. The method of claim 10, further comprising reacting the carbonate solution with the acid solution at about ambient temperature and about ambient pressure.

12. The method of claim 10, wherein producing the carbon dioxide stream comprises a first stage and a second stage, the first stage comprising thermally regenerating carbon dioxide from the carbonate solution, and the second stage comprising reacting the carbonate solution with the acid solution after the first stage.

13. The method of claim 12, further comprising adjusting the amount of carbon dioxide made at the first stage and the second stage based on the volume of the point source emissions and the amount of the point source impurities.

14. The method of claim 12, wherein reacting the carbonate solution with the acid solution comprises reacting a first portion of the carbonate solution, and further comprising recycling a second portion of the carbonate solution for reacting with the point source emissions.

15. The method of claim 12, wherein the point source emissions are received from an industrial facility and further comprising using waste heat from the industrial facility for thermally regenerating the carbon dioxide in the first stage.

16. The method of claim 10, further comprising treating the saline solution with nanofiltration, ion exchange, and reverse osmosis before electrochemically processing the saline solution.

17. The method of claim 10, further comprising purifying the carbon dioxide stream with a condenser, an absorber, and a liquefier.

18. A system for carbon dioxide capture and production, comprising:
electrodialysis equipment configured to electrochemically produce a base solution and an acid solution from a saline solution;
a direct air capture unit configured to contact the base solution with air comprising atmospheric carbon dioxide to produce a carbonate solution comprising carbonates and atmospheric impurities;
a reactor configured to mix the acid solution and the carbonate solution to produce carbon dioxide gas and a brine byproduct comprising essentially all the atmospheric impurities; and
a mixer configured to mix the brine byproduct with the saline solution prior to the electrodialysis equipment.

19. The system of claim 18, further comprising a bubble column reactor configured to contact the carbonate solution with point source emissions to produce bicarbonates and point source impurities in the carbonate solution, wherein the reactor is configured to produce the brine byproduct such that is further comprises essentially all the point source impurities.

20. The system of claim 19, further comprising a thermal reactor configured to use waste heat from an industrial facility supplying the point source emissions to thermally regenerate at least part of the carbon dioxide gas.
